(19) United States
(12) Patent Application Publication
(10) Pub. No.: US 2009/0274956 A1
(43) Pub. Date: Nov. 5, 2009

(54) BUS BAR

(76) Inventors: Shinichiro KOSUGI, Yokohama-shi (JP); Shun Egusa, Yokohama-shi (JP); Yoshinobu Makino, Machida-shi (JP); Masahiro Sekino, Tokyo (JP); Takeo Kakuchi, Chofu-shi (JP); Tamon Ozaki, Fuchu-shi (JP); Takafumi Nakahama, Fuchu-shi (JP); Nagaaki Muro, Kawasaki-shi (JP); Yuusaku Hata, Saku-shi (JP); Norihito Togashi, Yokohama-shi (JP); Kenji Sato, Hachioji-shi (JP); Kenji Shigehisa, Tokyo (JP); Tsutomu Kanetsuna, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/473,052

(22) Filed: May 27, 2009

Related U.S. Application Data
(63) Continuation of application No. PCT/JP2008/068004, filed on Sep. 26, 2008.

(30) Foreign Application Priority Data
Sep. 27, 2007 (JP) 2007-251600
Sep. 28, 2007 (JP) 2007-256622

(51) Int. Cl. H01M 2/20; H02G 5/00

(52) U.S. Cl. 429/158; 174/68.2

(57) ABSTRACT

There is provided a bus bar which electrically connects two terminals respectively provided to two batteries with each other and is formed of at least one tabular conductor, the bus bar including two connecting portions which are connected with the two terminals, and a convex portion formed into a convex shape between the two connecting portions by curving the tabular conductor.

### CROSS REFERENCE TO RELATED APPLICATIONS

This is a Continuation Application of PCT Application No. PCT/JP2008/068004, filed Sep. 26, 2008, which was published under PCT Article 21(2) in English.

This application is based upon and claims the benefit of priority from prior Japanese Patent Applications No. 2007-251600, filed Sep. 27, 2007; and No. 2007-256622, filed Sep. 28, 2007, the entire contents of both of which are incorporated herein by reference.

### BACKGROUND OF THE INVENTION

1. Field of the Invention

The present invention relates to a bus bar that electrically connects terminals of batteries with each other.

2. Description of the Related Art

In general, a bus bar is used to electrically connect terminals of a plurality of batteries with each other in some cases. Various kinds of bus bars exist. For example, there is a bus bar formed of two connecting members that connect a pair of battery cells with each other and a coupling member that further couples these connecting members with each other (see JP-A 2001-155702 (KOKAI)). Further, there is also a bus bar that connects an external connection positive electrode terminal and an external connection negative electrode terminal of respective battery modules with each other in series (see JP-A 2003-162993 (KOKAI)). Furthermore, there is a bus bar that completely fixes one end side of each of a plurality of storage elements with each other (see JP-A 2004-186232 (KOKAI)). There is also a connection conductor that electrically connects terminals of a plurality of batteries with each other (see JP-A 2006-339032 (KOKAI) and JP-A 2007-200758 (KOKAI)).

However, in the above-explained bus bars, when a distance between connected terminals is changed due to various factors, a burden imposed on each terminal is considerable.

### BRIEF SUMMARY OF THE INVENTION

It is an object of the present invention to provide a bus bar that can reduce a burden imposed on each terminal even if a distance between connected terminals is changed.

A bus bar according to an aspect of the present invention is a bus bar which electrically connects two terminals respectively provided to two batteries with each other and is formed of at least one tabular conductor, the bus bar comprising: two connecting portions which are connected with the two terminals; and a convex portion formed into a convex shape between the two connecting portions by curving the tabular conductor.

### BRIEF DESCRIPTION OF THE SEVERAL VIEWS OF THE DRAWING

FIG. 1 is a top view showing a shape of an upper surface of a bus bar according to a first embodiment of the present invention;

FIG. 2 is a front view showing a shape of a front surface of the bus bar according to the first embodiment;

FIG. 3 is a side view showing a side surface of the shape of the bus bar according to the first embodiment;

FIG. 4 is a perspective view showing a shape of a bus bar according to a modification of the first embodiment;

FIG. 5 is a block diagram of connection of a plurality of batteries showing a state where the bus bar according to the modification of the first embodiment is used;

FIG. 6 is a front view showing a front surface of a bus bar according to a second embodiment of the present invention;

FIG. 7 is a top view showing a shape of an upper surface of a bus bar according to a third embodiment of the present invention;

FIG. 8 is a front view showing a shape of a front surface of the bus bar according to the third embodiment;

FIG. 9 is a side view showing a shape of a side surface of the bus bar according to the third embodiment;

FIG. 10 is a top view showing a shape of an upper surface of a bus bar according to a fourth embodiment of the present invention;

FIG. 11 is a front view showing a shape of a front surface of the bus bar according to the fourth embodiment;

FIG. 12 is a side view showing a shape of a side surface of the bus bar according to the fourth embodiment;

FIG. 13 is a top view showing a shape of an upper surface of a bus bar according to a fifth embodiment of the present invention;

FIG. 14 is a front view showing a shape of a front surface of the bus bar according to the fifth embodiment;

FIG. 15 is a side view showing a shape of a side surface of the bus bar according to the fifth embodiment;

FIG. 16 is a front view showing a caulked joint where connecting portions of the bus bar according to the fifth embodiment are covered with a cylindrical metal thin plate to be joined;

FIG. 17 is a top view showing a shape of an upper surface of a bus bar according to a sixth embodiment of the present invention;

FIG. 18 is a front view showing a shape of a front surface of the bus bar according to the sixth embodiment;

FIG. 19 is a perspective view showing a shape of a bus bar according to a seventh embodiment of the present invention;

FIG. 20 is a perspective view showing a shape of a bus bar according to an eighth embodiment of the present invention;

FIG. 21 is a top view showing a shape of an upper surface of the bus bar according to the eighth embodiment of the present invention;

FIG. 22 is a development elevation in which the bus bar according to the eighth embodiment is developed into one tabular metal plate;

FIG. 23 is a perspective view showing a structure of an assembled battery to which the bus bars according to the eighth embodiment are applied;

FIG. 24 is a vertical cross-sectional view showing a structure of an electric cell constituting the assembled battery according to the eighth embodiment of the present invention;

FIG. 25 is an exploded diagram showing a structure of an assembled battery to which the bus bars according to the eighth embodiment are applied; and

FIG. 26 is a perspective view showing the structure of the assembled battery to which the bus bars according to the eighth embodiment are applied.

### DETAILED DESCRIPTION OF THE INVENTION

Hereinafter, referring to the accompanying drawings, embodiments of the present invention will be explained.

### First Embodiment

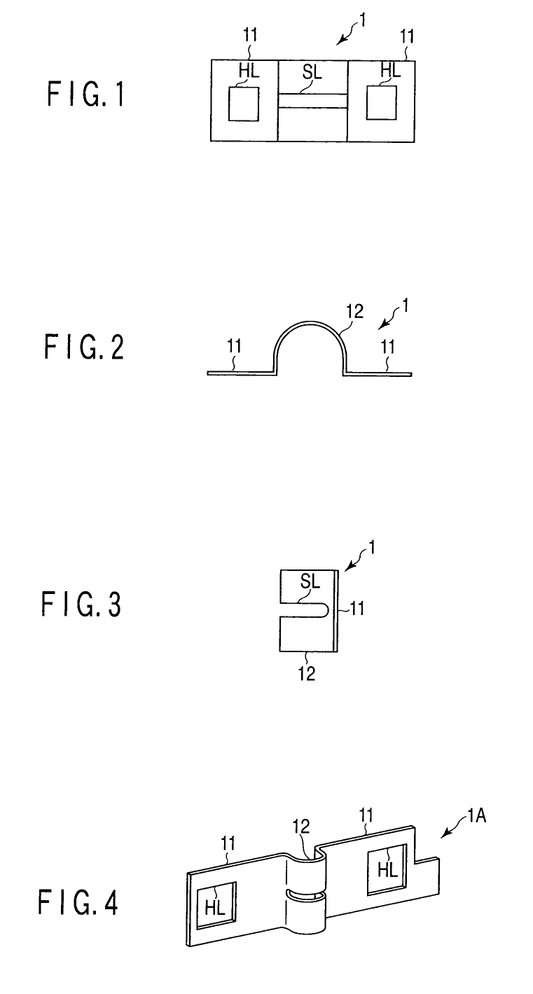

FIG. 1 is a top view showing a shape of an upper surface of a bus bar 1 according to a first embodiment of the present invention. FIG. 2 is a front view showing a shape of a front surface of the bus bar 1 according to this embodiment. FIG. 3 is a side view showing a shape of a side surface of the bus bar 1 according to this embodiment. It is to be noted that like reference numerals denote like parts to omit a detailed explanation thereof, and different parts will be mainly described. A tautological explanation will be likewise omitted in the subsequent embodiments.

In the bus bar 1, two connecting portions 11 that are connected with terminals respectively provided to two batteries and a convex portion 12 that is formed into a convex shape between these two connecting portions 11 are provided. In the bus bar 1, the two connecting portions 11 and the convex portion 12 are formed by molding one tabular metal plate (a conductive plate).

A hole HL is formed in the connecting portion 11 to facilitate connection with the terminal of the battery (a cell).

The convex portion 12 plays a role of buffering a force that functions in a connecting direction of the terminals of the two batteries. A convex shape of the convex portion 12 is formed to curve the tabular metal plate. That is, the convex portion 12 is formed to prevent a folding line from being formed.

Further, in the convex portion 12, a slit SL extended in the connecting direction of the terminals of the two batteries is formed. That is, the slit SL is extended in a direction along which the two connecting portions 11 are connected. The slit SL plays a role of buffering a force that functions in a direction vertical to the direction along which the slit SL is extended.

A state where bus bars 1A and 1B according to this embodiment are used will now be explained.

Each of the bus bars 1A and 1B is obtained by modifying the bus bar 1 in accordance with an object to be used (a secondary battery) or a place where each bus bar is used. For example, as shown in FIG. 4, the bus bar 1A is obtained by modifying the connecting portions 11 of the bus bar 1. Therefore, a basic structure of the bus bar 1A or 1B is the same as that of the bus bar 1.

FIG. 5 is a block diagram of connection of a plurality of batteries showing a state where the bus bars 1A and 1B according to this modification are used.

The battery 9 is, e.g., a rechargeable secondary battery.

Each of the bus bars 1A and 1B connects terminals having different polarities (a positive polarity or a negative polarity) of the two batteries 9 with each other. Here, the bus bar 1B has a shape that is suitable for connecting terminals of the superimposed batteries 9 with each other.

When each of the bus bars 1A and 1B is used, the two batteries 9 are connected in series. This is also the same when connecting the two batteries 9 in parallel. Connecting the plurality of batteries 9 in series or in parallel in this manner enables constituting a battery apparatus.

According to this embodiment, a spring constant of the bus bar 1 that connects batteries with each other can be reduced, and forces that are produced between the batteries due to, e.g., deformation of the batteries by vibration, an impact shock, or heat can be buffered. In the bus bar 1, providing the convex portion 12 enables reducing a burden imposed on terminals to be connected with respect to a force in a connecting direction of the terminals connected with the bus bar 1 and a force that functions in a direction vertical to the former force.

### Second Embodiment

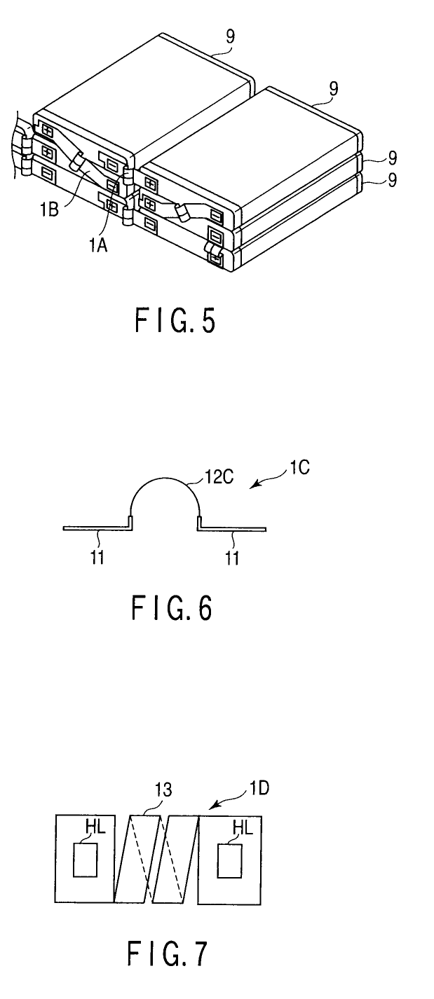

FIG. 6 is a front view showing a shape of a front surface of a bus bar 1C according to a second embodiment of the present invention.

In the bus bar 1C, a convex portion 12C is formed by molding a tabular material thinner than each connecting portion 11 in place of the convex portion 12 in the bus bar 1 according to the first embodiment. Other points are the same as those in the bus bar 1.

According to this embodiment, it is possible to obtain the following functions and effects in addition to the functions and effects provided by the first embodiment.

Since the convex portion 12C in the bus bar 1C is formed by molding the tabular material thinner than each connecting portion 11, a force in a connecting direction of terminals can be further reduced as compared with the bus bar 1 according to the first embodiment.

### Third Embodiment

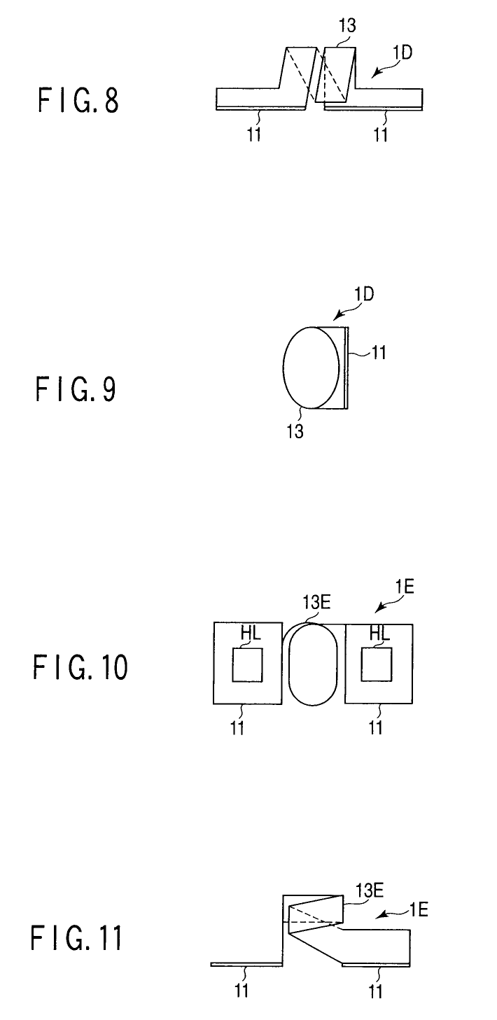

FIG. 7 is a top view showing a shape of an upper surface of a bus bar 1D according to a third embodiment of the present invention. FIG. 8 is a front view showing a shape of a front surface of the bus bar 1D according to this embodiment. FIG. 9 is a side view showing a shape of a side surface of the bus bar 1D according to this embodiment.

In the bus bar 1D, a spiral portion 13 is formed in place of the convex portion 12 in the bus bar 1 according to the first embodiment. In the bus bar 1D, two connecting portions 11 and the spiral portion 13 are formed by molding one tabular metal plate (a conductive plate). Other points are the same as those in the bus bar 1.

The spiral portion 13 is extended to be wound around a line in a connecting direction of terminals of two batteries. The spiral portion 13 plays a role of buffering forces in various directions that are applied to the terminals of the two batteries.

According to this embodiment, a spring constant of the bus bar 1D that connects batteries with each other can be reduced, and forces that are produced between the batteries due to, e.g., deformation of the batteries by vibration, an impact shock, or heat can be buffered. As a result, it is possible to reduce a burden imposed on the terminals to be connected with respect to various forces produced between the terminals connected with the bus bar 1D.

### Fourth Embodiment

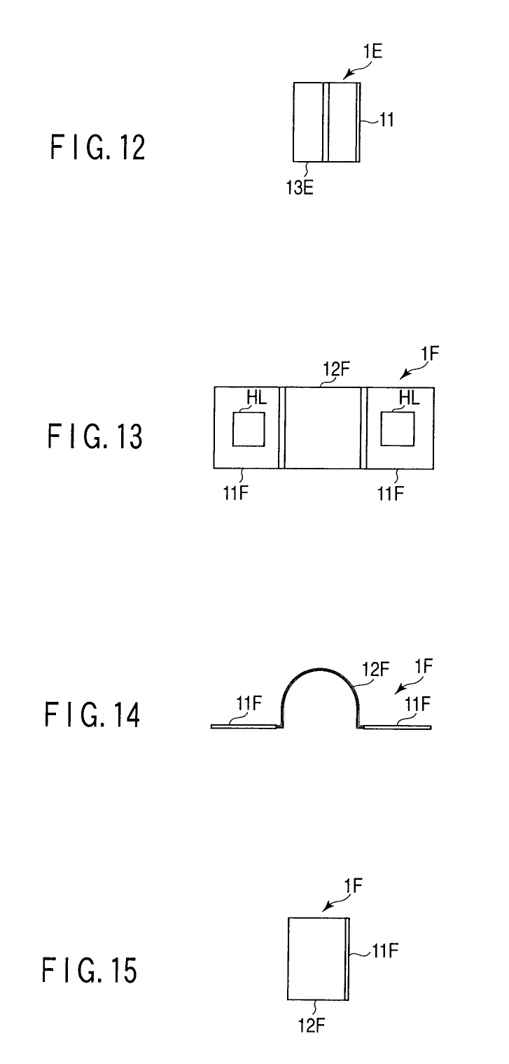

FIG. 10 is a top view showing a shape of an upper surface of a bus bar 1E according to a fourth embodiment of the present invention. FIG. 11 is a front view showing a shape of a front surface of the bus bar 1E according to this embodiment. FIG. 12 is a side view showing a shape of a side surface of the bus bar 1E according to this embodiment.

In the bus bar 1E, a spiral portion 13E is formed in place of the spiral portion 13 in the bus bar 1D according to the third embodiment. Other points are the same as those in the bus bar 1D.

The spiral portion 13E is the same as the spiral portion 13 according to the third embodiment except for a spiral direction. Specifically, assuming that a plane on which terminals of two batteries are provided is a horizontal direction, the spiral portion 13E is extended to be wound around a line in a vertical direction. The spiral portion 13E plays a role of buffering forces in various directions that are applied to the terminals of the two batteries.

According to this embodiment, forming the spiral portion 13E enables obtaining the same functions and effects as those in the third embodiment.

### Fifth Embodiment

FIG. 13 is a top view showing a shape of an upper surface of a bus bar 1F according to a fifth embodiment of the present invention. FIG. 14 is a front view showing a shape of a front surface of the bus bar 1F according to this embodiment. FIG. 15 is a side view showing a shape of a side surface of the bus bar 1F according to this embodiment.

In the bus bar 1F, a convex portion 12F is formed in place of the convex portion 12 in the bus bar 1 according to the first embodiment and two connecting portions 11F are formed in place of the two connecting portions 11 in the same. The bus bar 1F has a shape obtained by superimposing a plurality of thin tabular conductors as a whole. Other points are the same as those in the bus bar 1.

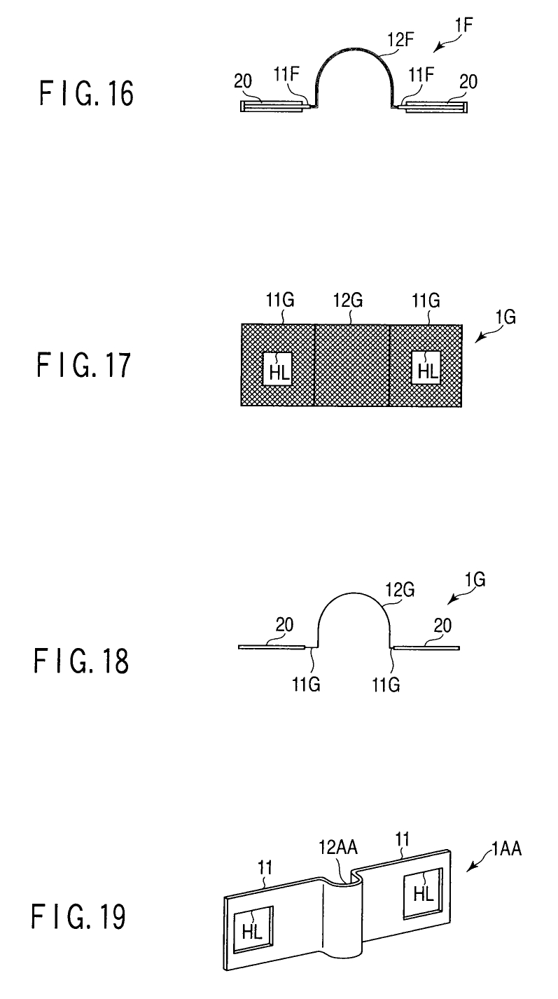

The connecting portion 11F has a shape obtained by superimposing a plurality of tabular materials each having a thickness smaller than a thickness of the connecting portion 11 according to the first embodiment. Moreover, the plurality of superimposed tabular materials are bonded to be integrated. A bonding scheme is, e.g., ultrasonic bonding, solder joint, caulked joint, or laser welding. For example, the caulked joint uses a scheme in which a cylindrical metal thin plate 20 is placed to perform bonding as shown in FIG. 16. Additionally, the caulked joint may be effected by simply performing pressure bonding. Laser welding is a scheme that uses a CW laser (a continuous laser) to carry out bonding. Since bonding can be mechanically effected by ultrasonic bonding, caulked joint, or laser welding, the connecting portions 11F can be produced in large quantities. If the solder joint is adopted, a strong bond is enabled.

The convex portion 12F has a shape obtained by superimposing a plurality of tabular materials each having a thickness smaller than a thickness of the convex portion 12 according to the first embodiment. Here, the convex portion 12F has a shape with no slit, but a slit may be formed in this portion.

According to this embodiment, a spring constant of the bus bar 1F that connects batteries with each other can be reduced, and forces that are produced between the batteries due to, e.g., deformation of the batteries by vibration, an impact shock, or heat can be buffered. As a result, it is possible to reduce a burden imposed on terminals to be connected with each other with respect to a force in a connecting direction of the terminals connected with the bus bar 1F.

Since the bus bar 1F is obtained by molding one tabular material constituting the convex portion 12F to be thinner than the convex portion 12C, the force in the connecting direction of the terminals can be further reduced as compared with the bus bar 1 according to the first embodiment.

Further, superimposing a plurality of tabular conductors enables decreasing a resistance value between the terminals which are connected with each other.

### Sixth Embodiment

FIG. 17 is a top view showing a shape of an upper surface of a bus bar 1G according to a sixth embodiment of the present invention. FIG. 18 is a front view showing a shape of a front surface of the bus bar 1G according to this embodiment.

In the bus bar 1G, a convex portion 12G is formed in place of the convex portion 12 in the bus bar 1 according to the first embodiment and two connecting portions 11G are formed in place of the two connecting portions 11 in the same. The bus bar 1G is obtained by molding a tabular flat braided wire as a whole. Other points are the same as those in the bus bar 1.

The connecting portion 11G has a shape obtained by forming the connecting portion 11 according to the first embodiment by using a flat braided wire.

The convex portion 12G has a shape obtained by forming the convex portion 12 according to the first embodiment by using a flat braided wire. Here, the convex portion 12G has a shape with no slit, but a slit may be formed in this portion.

According to this embodiment, a spring constant of the bus bar 1G that connects batteries with each other can be reduced, and forces that is produced between the batteries due to, e.g., deformation of the batteries by vibration, an impact shock, or heat can be buffered. As a result, it is possible to reduce a burden imposed on terminals as connection targets with respect to a force in a connecting direction of the terminals connected with the bus bar 1G.

Forming the bus bar 1 of a flat braided wire as a whole enables reducing a burden imposed on the terminals as connection targets with respect to various forces that act on the terminals connected with the bus bar 1G.

### Seventh Embodiment

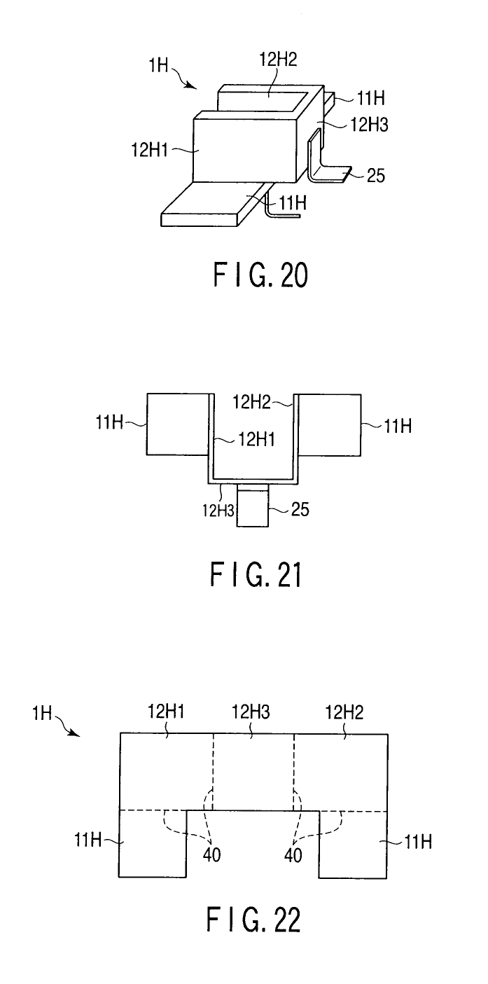

FIG. 19 is a perspective view showing a shape of a bus bar 1AA according to a seventh embodiment of the present invention.

In the bus bar 1AA, a convex portion 12AA is formed in place of the convex portion 12 in the bus bar 1 according to the first embodiment. The convex portion 12AA does not have the slit SL of the convex portion 12 formed therein. Other points are the same as those in the bus bar 1.

In the convex portion 12AA, a convex shape is formed to curve a tabular metal plate. That is, the convex portion 12AA is formed to prevent a folding line.

According to this embodiment, a spring constant of the bus bar 1AA that connect batteries with each other can be reduced, and forces that are produced between the batteries due to, e.g., deformation of the batteries by vibration, an impact shock, or heat can be buffered. In the bus bar 1AA, providing the convex portion 12AA enables reducing a burden imposed on terminals as connection targets with respect to a force in a connecting direction of the terminals connected with the bus bar 1AA.

According to the bus bar 1AA, providing the convex portion 12AA enables buffering a force that changes a distance between the two terminals connected with the bus bar 1AA even though the slit SL according to the first embodiment is not provided. As a result, the bus bar 1AA can reduce a burden imposed on the terminals as connection targets with respect to the force in the connecting direction of the two connected terminals.

### Eighth Embodiment

FIG. 20 is a perspective view showing a shape of a bus bar 1H according to an eighth embodiment of the present invention. FIG. 21 is a top view showing an upper surface of the shape of the bus bar 1H according to this embodiment. FIG. 22 is a development elevation in which the bus bar 1H according to this embodiment is developed into one tabular metal plate.

The bus bar 1H is formed by bending one tabular metal plate (a flat plate) to form four folding lines 40 at a right angle as shown in FIGS. 20, 21, and 22. Two of the four folding lines 40 are substantially parallel to each other. The two parallel folding lines 40 are substantially vertical to the other two folding lines 40. The bus bar 1H is formed of a conductive material such as aluminum or copper.

In the bus bar 1H, two connecting portions 11H that are connected with terminals provided to two batteries and three vertical surfaces 12H1, 12H2, and 12H3 are provided. A basic structure of the bus bar 1H is the same as the bus bar 1 according to the first embodiment. That is, the three vertical surfaces 12H1, 12H2, and 12H3 form a shape corresponding to the convex portion 12 of the bus bar 1.

The connecting portion 11H has a shape having no hole HL in the connecting portion 11 according to the first embodiment. It is to be noted that the connecting portion 11H may have a shape having the hole HL formed therein. Other points of the connecting portion 11H are the same as those in the connecting portion 11. The connecting portion 11H is placed at each of both ends. A surface of each connecting portion 11H is placed in a horizontally extended direction. The connecting portions 11H are bonded to terminals of batteries, respectively.

The three vertical surfaces 12H1, 12H2, and 12H3 are arranged on the inner side of the two connecting portions 11. The two vertical surfaces 12H1 and 12H2 are arranged to rise in a perpendicular direction in such a manner that they face each other in parallel. The vertical surface 12H3 is arranged to connect respective side ends placed in the same direction of the two vertical surfaces 12H1 and 12H2 with each other. The vertical surface 12H3 is arranged to rise in the perpendicular direction. A surface of the vertical surface 12H3 is placed in a perpendicularly extended direction.

A connection piece 25 is provided on the vertical surface 12H3. The connection piece 25 is bonded to the vertical surface 12H3 by, e.g., ultrasonic welding or resistance welding. The connection piece 25 has a shape obtained by bending a flat plate into an L-like shape. The connection piece 25 is, e.g., a thin plate formed of nickel. The connection piece 25 is disposed to electrically connect the bus bar 1 with a wiring line that is required to measure a voltage.

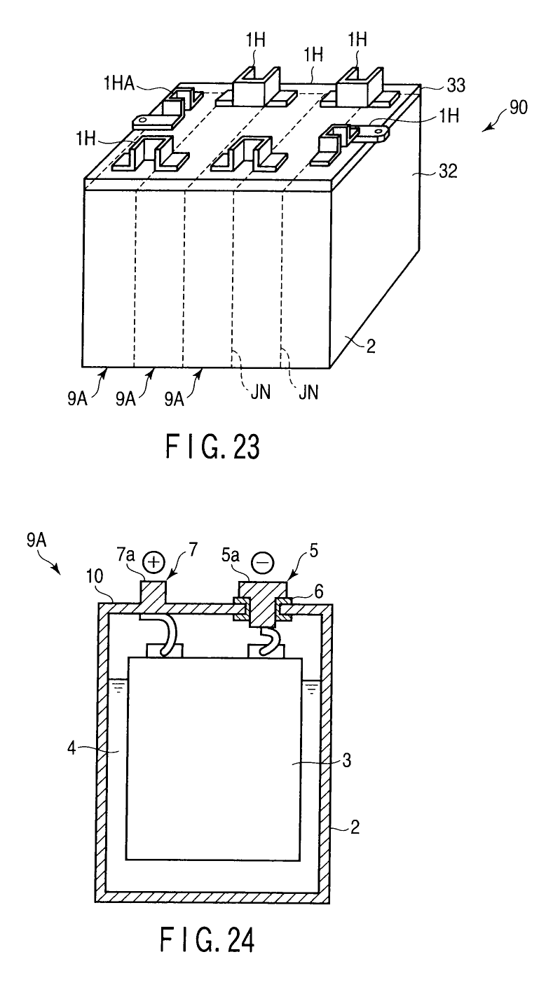

FIG. 23 is a perspective view showing a structure of an assembled battery 90 to which the bus bar 1H according to this embodiment is applied.

The assembled battery 90 includes five electric cells 9A combined with each other, bus bars 1H and 1HA electrically connected with terminals of the five electric cells 9A, and a voltage measurement substrate 33 arranged to cover an upper surface of the assembled battery 90. A tape 32 is wound around a side surface of the assembled battery 90.

FIG. 24 is a vertical cross-sectional view showing a structure of the electric cell 9A constituting the assembled battery 90 according to this embodiment.

The electric cell 9A includes a battery case 2, an electrode group 3, an electrolyte 4, a negative electrode terminal 5, and a sealing material 6. A positive electrode terminal 7 forms a part of the battery case 2. The electric cell 9A is, e.g., a lithium-ion battery.

The battery case 2 has a flat rectangular solid shape. The battery case 2 accommodates components constituting the electric cell 9A. The battery case 2 is formed of a metal, e.g., aluminum. That is, the battery case 2 has electrical conductivity.

The electrolyte 4 fills the battery case 2.

The electrode group 3 is immersed in the electrolyte 4 in the battery case 2. A positive electrode side of the electrode group 3 is electrically connected with an inner surface of a terminal-side end face 10 of the battery case 2. A negative electrode side of the electrode group 3 is connected with a negative electrode terminal 5 in the battery case 2.

The positive electrode terminal 7 is formed to protrude from the terminal-side end face 10. The positive electrode terminal 7 is formed at an outer position corresponding to a position where the positive electrode side of the electrode group 3 in the battery case 2 is connected. The positive electrode terminal 7 is a terminal of a positive electrode connected with a terminal of another electric cell 9A. A distal facet 7a of the positive electrode terminal 7 is a surface that is bonded to a connecting portion 11H of the bus bar 1H.

The negative electrode terminal 5 is a terminal of a negative electrode connected with a terminal of another electric cell 9A. The negative electrode terminal 5 pierces the terminal-side end face 10 of the battery case 2. A distal facet 5a of the negative electrode terminal 5 is provided to have substantially the same height as the distal facet 7a of the positive electrode terminal 7 from the terminal-side end face 10. The distal facet 5a of the negative electrode terminal 5 is a surface that is bonded to the connecting portion 11H of the bus bar 1H. The negative electrode terminal 5 is formed of a metal, e.g., aluminum or copper.

The sealing material 6 has electrical insulating properties. The sealing material 6 electrically insulates the negative electrode terminal 5 from the battery case 2. The sealing material 6 plays a role of hermetically closing a hole of the battery case 2 in which the negative electrode terminal 5 is inserted. That is, the sealing material 6 is provided to maintain airtightness in the battery case 2. This airtightness prevents moisture from entering the battery case 2. The sealing material 6 is formed of, e.g., plastic.

The assembled battery 90 is formed by bonding the electric cells 9A at joint surfaces JN. Bonding at the joint surfaces JN is carried out by using, e.g., a pressure-sensitive adhesive double coated tape or an adhesive. In the electric cell 9A, a relatively wide surface is determined as the joint surface JN. The joint surface JN is a surface placed to be adjacent to the terminal-side end face 10. All the electric cells 9A are arranged in such a manner that the terminal-side end faces 10 are placed on the same plane. The tape 32 is wound around the side surface of the assembled battery 90 to fix the electric cells 9A as a bundle. The tape 32 is, e.g., a pressure-sensitive adhesive tape or a heat-shrinkable tape.

The bus bar 1H electrically connects the negative electrode terminal 5 of the electric cell 9A with the positive electrode terminal 7 of another electric cell 9A. The five electric cells 9A are connected in series by the bus bars 1H. The respective terminals 5 and 7 of the electric cells 9A are protruded on the upper surface of the assembled battery 90 through the voltage measurement substrate 33. Therefore, the bus bars 1H are arranged on the voltage measurement substrate 33.

In the bus bar 1HA, one of the two connecting portions 11H has a shape suitable for connecting the assembled battery 90 with any other device. In regard to other points, the bus bar 1HA has the same shape as the bus bar 1H.

The voltage measurement substrate 33 is a substrate that is used to measure a voltage of each electric cell 9A constituting the assembled battery 90. The voltage measurement substrate 33 is formed of an insulating material, e.g., fiber-reinforced plastic (FRP) such as glass fiber filled epoxy.

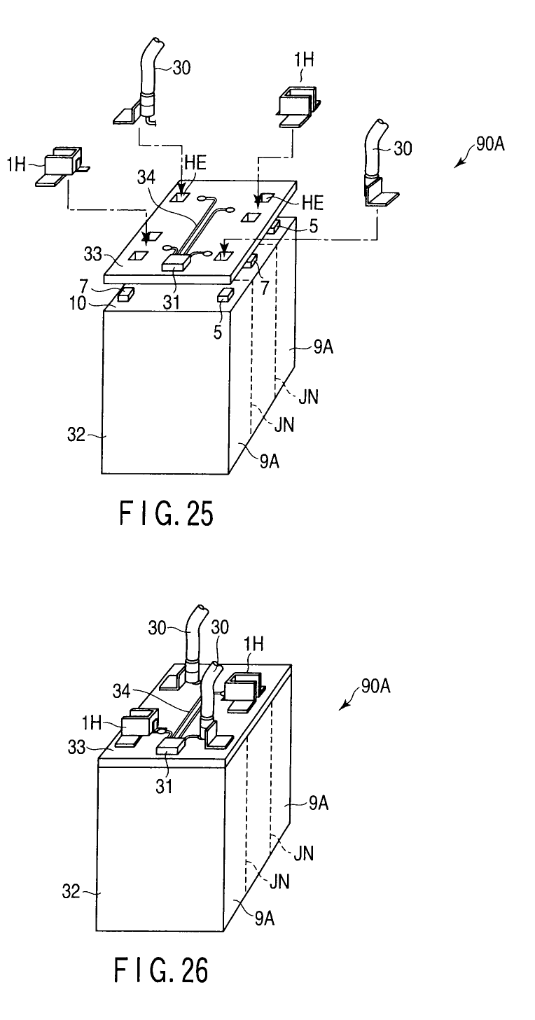

FIG. 25 is an exploded diagram showing a structure of an assembled battery 90A to which the bus bar 1H according to this embodiment is applied. FIG. 26 is a perspective view showing the structure of the assembled battery 90A to which the bus bar 1H according to this embodiment is applied.

The assembled battery 90A is formed by combining three electric cells 9A. In regard to other points, the assembled battery 90A has the same structure as the assembled battery 90 depicted in FIG. 23.

A voltage measurement substrate 33 is arranged to cover an entire terminal-side end face 10 of the whole assembled battery 90. A plurality of electrode terminal holes HE through which negative electrode terminals 5 and positive electrode terminals 7 are inserted are formed in the voltage measurement substrate 33. A voltage measurement pattern 34 and a voltage measurement connector 31 are provided on the voltage measurement substrate 33.

The negative electrode terminals 5 and the positive electrode terminals 7 of all the electric cells 9A protrude through the corresponding electrode terminal holes HE. These negative electrode terminals 5 and positive electrode terminals 7 are connected in series by using two bus bars 1H.

The voltage measurement pattern 34 is an electric circuit formed of a wiring line made of, e.g., copper. The voltage measurement pattern 34 is electrically connected with the voltage measurement connector 31.

Connection pieces 25 are soldered to the voltage measurement pattern 34. As a result, each connection piece 25 electrically connects the bus bar 1H with the voltage measurement pattern 34.

All the electric cells 9A are connected in series by the bus bars 1H. The negative electrode terminal 5 and the positive electrode terminal 7 at both ends of the electric cells 9A connected in series are connected with current extraction lines 30, respectively. Each current extraction line 30 electrically connects the assembled battery 90A with a target device to which a current is supplied (not shown).

The connection piece 25 electrically connected with each bus bar 1H is connected with one voltage measurement connector 31 through the voltage measurement pattern 34. The voltage measurement connector 31 transmits a voltage signal for each electrical battery 9A to a voltage measuring device (not shown) disposed outside the assembled battery 90A. As a result, this voltage measuring device measures a voltage of each electric cell 9A.

According to this embodiment, the bus bar 1H has a shape obtained by three-dimensionally bending a plate material at four positions. Therefore, the bus bar 1H is apt to be deformed in various directions. Therefore, the same functions and effects as those in the first embodiment can be obtained.

Furthermore, the assembled battery 90 or 90A is constituted by electrically connecting the electric cells 9A through the bus bar 1H. Therefore, even if positions of the two electric cells 9A connected to one bus bar 1H are shifted, electrical connection achieved between the electrodes of the two electric cells 9A can be maintained. Moreover, each bus bar 1H can suppress a large force from being applied to a sealing material 9 interposed between the negative electrode terminal 5 and a battery case 2. As a result, it is possible to prevent external moisture from entering the battery case 2 due to deformation of the sealing material 6.

When the battery apparatus, e.g., the assembled battery is constituted by using the electric cells in this manner, each electric cell is often formed of at least two types of materials, i.e., a metal as a conductive material and a plastic as an electric insulating material. This electric insulating material is used to electrically insulate the conductive material such as an electrode terminal from other members. These two types of materials have different coefficients of thermal expansion. Based on this difference between coefficients of expansion, a distance between the terminals of the two electric cells is reduced or increased due to heat generation when the terminals of such two electric cells are connected with each other. In such a case, when the bus bars 1H are used to configure, e.g., the battery apparatus, electrical connection between the terminals can be held with respect to the above-explained deformation.

Additionally, since the bus bar 1H has a simple structure obtained by simply bending a flat plate, a manufacturing cost can be reduced.

It is to be noted that each embodiment can be modified as follows.

In the first embodiment and the second embodiment, the number of the slits does not have to be one, and many slits may be provided.

In the third embodiment and the fourth embodiment, the spiral portions 13 and 13E are formed, but any other spiral portion may be formed. For example, the spiral portion may be a spiral having a shape that winds itself around a line in a direction perpendicular to each of axes of the spiral portions 13 and 13E (a direction cutting across a space between the terminals). Further, a spiral may be formed in a direction different from the directions parallel to and vertical to the connecting directions of the terminals.

In the fifth embodiment, various bonding schemes adopted when forming the connecting portion 11F have been explained. These bonding schemes can be used as schemes of bonding the connecting portion of the bus bar according to each embodiment with the terminal of the battery.

Although each of the fifth embodiment and the sixth embodiment has a structure based on the bus bar 1 according to the first embodiment, it may have a structure based on the bus bar according to each of the second embodiment to the fourth embodiment or may have a structure based on any other embodiment or modification. As a result, it is possible to obtain the functions and effects in the fifth embodiment or the sixth embodiment in addition to the functions and effects in each embodiment.

Although the slits are not provided in the convex portions 12F and 12G of the bus bars 1F and 1G in the fifth embodiment and the sixth embodiment, the slits may be provided. When the slits are provided, it is possible to obtain the same functions and effect as those in the first embodiment in addition to the functions and effects in each embodiment. Moreover, the number of the slits to be provided is arbitrary.

Although the battery case 2 has a positive polarity and the negative electrode terminal 5 is provided as a negative polarity in the electric cell 9A in the eighth embodiment, the polarities may be reversed. That is, the electric cell may have a structure where the battery case has a negative polarity and the positive electrode terminal is provided as a positive polarity. In this case, the sealing material 6 is arranged between the battery case and the positive electrode terminal.

In the eighth embodiment, the bus bar 1H is bent to form the four folding lines 40 at a right angle, but the bus bar 1H is not restricted to this structure. The number of the folding lines 40 of the bus bar 1H is arbitrary as long as all the folding lines 40 are not provided in parallel to each other. Additionally, the bus bar 1H does not have to be bent at the folding lines 40 at a right angle. Further, the bus bar 1H does not have to be bent. That is, the bus bar 1H may have a shape that is curved in a plurality of directions.

Although the assembled battery 90 or 90A is constituted by using the bus bars 1H in the eighth embodiment, it may be constituted by using the bus bars according to the other embodiments. In this case, it is possible to obtain the same functions and effects as those in a case where the bus bars 1H according to the eighth embodiment are used.

The number of the electric cells 9A constituting the assembled battery 90 or 90A is not restricted to three or five in the eighth embodiment, and this number is arbitrary as long as it is two or above.

Although the bus bar basically has an integral shape in each embodiment, respective portions may be individually formed and these respective portions may be bonded to each other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A bus bar which electrically connects two terminals respectively provided to two batteries with each other and is formed of at least one tabular conductor, the bus bar comprising:
two connecting portions which are connected with the two terminals; and
a convex portion formed into a convex shape between the two connecting portions by curving the tabular conductor.

2. The bus bar according to claim 1, wherein at least one slit extended in a connecting direction along which the two terminals are connected with each other is provided in the convex portion.

3. The bus bar according to claim 1, wherein the convex portion is formed of the tabular material having a thickness smaller than thicknesses of the two connecting portions.

4. The bus bar according to claim 1, wherein the convex portion is formed by superimposing tabular materials.

5. A bus bar which electrically connects two terminals respectively provided to two batteries with each other and is formed of at least one tabular conductor, the bus bar comprising:
two connecting portions which are connected with the two terminals; and
a spiral portion formed into a spiral shape between the two connecting portions.

6. The bus bar according to claim 5, wherein the spiral portion is formed by superimposing tabular materials.

7. A bus bar which electrically connects two terminals respectively provided to two batteries with each other and is formed of at least one tabular conductor, the bus bar comprising:
two connecting portions which are connected with the two terminals; and
a bending portions formed between the two connecting portions by bending the tabular conductor to form folding lines at least two of which are not parallel to each other.

8. A bus bar which electrically connects two terminals respectively provided to two batteries with each other and is formed of at least one tabular conductor, the bus bar comprising:
two connecting portions which are extended in a first direction to be connected with the two terminals;
two vertical portions extended in a second direction vertical to the first direction to face each other between the two connecting portions; and
a jointing portion which connects the two vertical portions with each other.

9. The bus bar according to claim 8, wherein the joining portion includes a connection piece connected with a wiring line which is used to measure a voltage applied to the two terminals.

10. The bus bar according to claim 1, wherein a flat braided wire is used as the tabular conductor.

11. A battery apparatus comprising:
two batteries including respective terminals; and
a bus bar which electrically connects two terminals respectively provided to two batteries with each other and is formed of at least one tabular conductor;
the bus bar including;
two connecting portions which are connected with the two terminals; and
a convex portion formed into a convex shape between the two connecting portions by curving the tabular conductor.

12. The battery apparatus according to claim 11, wherein each of the two batteries comprises an electric insulating material which electrically insulates one of the two terminals from other members.
